(19) United States
(12) Patent Application Publication
(10) Pub. No.: US 2009/0293305 A1
(43) Pub. Date: Dec. 3, 2009

(54) Full length airbag

(75) Inventors: David Pelsue, Aliso Viejo, CA (US); Vincent Fleming, Laguna Beach, CA (US); Lenny M. Holden, Trabuco Canyon, CA (US); Walid Motawi, Ladera Ranch, CA (US)

Correspondence Address: STETINA BRUNDA GARRED & BRUCKER, 75 ENTERPRISE, SUITE 250, ALISO VIEJO, CA, 92656, US

(73) Assignee: ST IP, LLC

(21) Appl. No.: 12/156,295

(22) Filed: May 30, 2008

(51) Int. Cl. A43B 13/20; B29C 47/04

(52) U.S. Cl. 36/29; 264/510

(57) ABSTRACT

A sole of a footwear is provided herein which may be designed to provide multifunctions suitable for particular sports. The sole may include a bladder which extends an entire length of a wearer's foot. The bladder may be pressurized with fluid for absorbing impact forces (e.g., landing impact forces, running impact forces, etc.). To prevent the bladder from having a balloon configuration, support columns may be attached to an upper layer and a lower layer of the bladder to maintain the spacing between the upper and lower layers. The lower layer of the bladder may be flat for optimizing the sole for skateboarding and other activity.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to footwear, and more particularly, a shoe designed for a particular activity (e.g., skateboarding, etc.).

One of the basic purposes of a shoe is to protect a bottom surface of the wearer's foot. For example, while the wearer walks on ground, the ground may be sharp or contain various sharp objects (e.g., broken glass) or other dull objects (e.g., rocks) that may pierce the bottom surface of the wearer's foot. These objects may hurt a person's foot if person is barefoot. Fortunately, the person may wear shoes which prevent the sharp or dull object(s) from penetrating the bottom surface of the wearer's feet. Instead, the object pierces a sole of the shoe and distributes such force about a greater surface area to mitigate damage to the bottom surface of the wearer's foot.

Footwear has evolved from a device which provides a basic barrier protection function to a device which may assist the wearer in participating in an extreme sport. By way of example and not limitation, a snowboard boot provides the basic barrier protection function to the bottom surface of the wearer's foot when the wearer is not snowboarding but walking around at the ski lodge. However, the snowboard boot additionally provides a means to attach the wearer's feet to the snowboard. In particular, the snowboard may have bindings wherein the snowboard boots are removably attachable to the bindings. Without the snowboard boot, straps of the bindings may uncomfortably squeeze the wearer's feet. Fortunately, the snowboard boot may be padded to prevent the straps of the snowboard binding from hurting the wearer's feet. Accordingly, snowboard boots may protect the wearer's feet from objects on the ground and also provide a means for attaching the wearer's feet to the snowboard. Additionally, snowboard boots may be designed to attenuate shocks. For example, when the snowboarder obtains air or jumps, upon landing, the snowboard boots may absorb the landing shocks so as to protect the wearer's ankles, knees, hips and overall body from jarring impact forces.

In a different extreme sport, a shoe may be worn for skateboarding. In skateboarding, the wearer's feet intricately manipulate the skateboard by applying pressure on various areas of the skateboard to perform various tricks. Accordingly, the skateboard shoe should be able to transfer the foot pressures applied by the skateboarder through the sole of the shoe to the board immediately. The skateboard shoe should also be able to attenuate landing impact forces when the skateboarder makes a jump. These are conflicting functions in that the skateboard shoe should provide optimal cushioning as well as optimal rigidity. Accordingly, there is a need in the art for an improved footwear that may provide optimal functioning for a particular sport or activity. One effective method of attenuating impact forces is shown and described in U.S. Pat. No. 7,020,988, issued to Holden et al. and assigned to Pierre Andre Senizergues.

Prior art footwear does exist that attempt to address the functional requirements of a particular sport but contain numerous deficiencies. By way of example and not limitation, U.S. Pat. No. 7,086,179 issued to Dojan et al. is a fluid filled bladder. As understood, the fluid within the bladder is pressurized such that the bladder may attenuate landing impact forces while a wearer of the shoe is running. Unfortunately, the fluid filled bladder also requires a reinforcement structure to maintain the shape of the fluid filled bladder due to the fluid pressure. The reinforcement structure is used to prevent the fluid filled bladder from excessively expanding or ballooning up when the fluid is pressurized to a pressure greater than ambient atmospheric pressure. The reinforcement structure makes the sole of the shoe discussed in U.S. Pat. No. 7,086,179 complex to manufacture and design.

Another example of a deficient cushioning member of a shoe sole is described and shown in U.S. Pat. No. 6,374,514, issued to Swigart. In this patent, a fluid filled bladder is provided. Ovoid shaped indentations are formed in the upper surface of the fluid filled bladder. Such indentations are elongate and have a small radius end providing a hard cushion and a large radius end providing a soft cushion. By selectively positioning and orienting these indentations, selective areas of the cushion may be softer or harder to compress. Unfortunately, a shoe incorporating such features is difficult to design for a particular sport. The reason is that the small radius end will always be immediately adjacent the larger radius end. Certain large areas of a cushion may need to be soft or hard. The ovoid shaped indentations provide a soft cushion area immediately adjacent a hard cushion area preventing large areas from having a soft or hard feel. Another deficiency of the Swigart device is that separate inserts are inserted into separate individual indentations. Each insert appears to be individually fitted into the indentation and cemented therein thereby increasing the time and cost to manufacture the product. Another deficiency of the Swigart device is that indentations are made in both the upper and lower surfaces of the bladder. The upper and lower indentations meet internal to the bladder so as to form an internal bond. Accordingly, the insert does not continuously extend from the top surface to the bottom surface. Rather, an upper insert extends from the top surface toward the middle of the bladder. A lower insert extends from the lower surface toward the middle of the bladder. The upper and lower inserts “contact” each other at the internal bond. Since the insert does not continuously extend through the entire height of the bladder, the impact absorption and resiliency of the insert is limited. Also, the indented lower surface produces a contoured lower surface which may not be optimal in performing intricate maneuvers.

Prior art footwear fails to address the specific needs of a particular sport. By way of example, prior art footwear fails to address the needs of a particular sport or anticipated movement when participating in the sport and the functional anatomy of the foot. Moreover, in skateboarding, prior art footwear fails to enhance cushioning, support, stability, rear foot control, durability, flexibility, weight reduction, pressure distribution, board feel and responsiveness, regional adaptation to a range of forces (i.e., impact forces and actively applied forces), fit and conformance of morphology of the plantar surface of the foot.

Based on the foregoing discussion, there is a need in the art for an improved shoe sole structure.

### BRIEF SUMMARY

A sole of a shoe is discussed herein which addresses one or more of the various deficiencies discussed above, discussed below or those that are known in the art.

The sole of the shoe may comprise a midsole, an outsole and a bladder. The midsole may be fabricated from cloth material, plastic material, rubber material, elastomeric material, synthetic rubber, neoprene, polyurethane or combinations thereof. The midsole may be optimized to provide a comfortable interface between a bottom surface of a wearer's foot and the sole. One of the functions of the midsole may be to distribute, mitigate or attenuate the load imposed by the wearer's foot on the outsole and the bladder.

The outsole may be fabricated from a material which is strong, resilient, and wear-resistant. By way of example and not limitation, the outsole may be fabricated from an elastomeric material, synthetic rubber, neoprene, polyurethane or the like. Similar to the midsole, the outsole may serve to distribute, mitigate or attenuate the load imposed by the wearer's foot on the midsole and the bladder. The outsole may further be optimized to (1) increase the frictional coefficient between the shoe and the ground or other contact surfaces such that the wearer does not slip and fall when performing athletic maneuvers during sports competition or leisure and/or (2) to resist wear.

The bladder may incorporate one or more of the following aspects which alone or in combinations with each other may provide specific solutions for impact absorption, resiliency, cushioning, support, stability, rear foot control, durability, flexibility, weight-reduction, pressure distribution board feel, responsiveness, regional adaptation to a range of forces (i.e., impact forces and actively applied forces), even fit and/or fit and conformance of morphology of the plantar surface of the foot.

In an aspect of the bladder, the same may comprise an upper layer, lower layer and a peripheral wall which joins the upper and lower layers. Each of the upper layer, lower layer and peripheral wall may define properties including but not limited to thickness, stretchability, elasticity and stiffness. The thickness, stretchability, elasticity, stiffness and/or other property of the upper layer, lower layer and the peripheral wall may be different between any two or all three of the upper layer, lower layer and the peripheral wall. These differences, as will be discussed below, may be used for a variety of purposes including to shape a top surface of the upper layer so as to configure the same to provide optimal functionality for a particular sport or activity.

In another aspect of the bladder, support columns may be formed between or attached to the upper layer and the lower layer. The support columns may be formed by indenting the upper layer. The support columns may reach the flat lower layer and be bonded to the lower layer thereby the lower layer may remain flat. When the bladder is pressurized to a pressure greater than ambient pressure, the upper layer of the sole will not excessively balloon up or bow outwardly. The support columns help to maintain the space or distance between the upper layer and the lower layer. Moreover, the bladder does not need an external reinforcement to maintain the shape of the bladder. The support columns assist in maintaining the shape of the bladder.

More particularly, to prevent the bladder from having a balloon configuration when pressurized to a pressure greater than ambient pressure, certain portions of the upper layer may be attached to corresponding portions of the lower layer. These portions form a plurality of support columns. Each of the support columns may have a column wall and a base. The base may be attached (e.g., adhered, welded, sonic welded, heat welded, melted, etc.) to the lower layer. For example, as discussed herein, the base may be attached to the lower layer by taking advantage of the melt phase when the indentations are formed in the upper layer. The column wall may extend between and be attached to an outer periphery of the base and the inner periphery of an opening formed in the upper layer. The column wall of the support column may hold the upper layer in position with respect to the lower layer when the fluid within the bladder is pressurized to a pressure greater than ambient pressure. The column walls resist the outward expansive forces of the pressurized fluid to maintain the distance between the upper layer and the lower layer. Conversely, the column walls may generally mitigate compression of the bladder upon compression of the bladder by an impact between the wearer's foot and a support surface (e.g., ground, board of a skateboard, board of a snowboard, etc.). It is contemplated that the column wall may be slenderized or fabricated from a material that would optimally absorb impacts to optimally attenuate the impact forces imposed on the bladder. It's also contemplated that the column wall may be generally perpendicularly oriented to the upper and lower layers or oriented at a skewed angle with respect to the upper and/or lower layers.

When the fluid contained within the bladder is pressurized, the upper and lower layer may tend to bow outwardly. To mitigate against such outward bowing of the lower layer, the lower layer may be fabricated from a generally stiff material. The lower layer may also be made thicker to minimize such outward bowing. As such, the pressure of the fluid attempts to bow the lower layer outwardly. However, the stiffness of the lower layer resists such outward bowing. The pressure of the fluid also attempts to bow the upper layer outwardly. However, the support columns are anchored to the stiff lower layer and attached to the upper layer to control the outward bowing of the upper layer.

The fluid pressure generally bulges the upper layer outward. The contour of the top surface of the upper layer may be controlled by altering the specific thickness, stiffness, stretchability and elasticity of the upper layer. Also, the contour of the top surface of the upper layer may be controlled by positioning the support columns close to each other or far apart from each other. By way of example and not limitation, the outer peripheral portion of the upper layer at the heel region may be fabricated from a thin, flexible, stretchable and elastic material. Support columns may be formed so as to attach a central portion of the upper layer to the lower layer. In this manner, when the fluid within the bladder 16 is pressurized, the outer peripheral portion of the upper layer at the heel region would tend to bow outwardly and the central portion of the upper portion may remain flat and close to the lower layer. The amount of outward bowing of the upper layer at the outer peripheral portion may also be controlled by strategically positioning support columns next to each other and adjacent the peripheral wall of the bladder at the outer peripheral portion. By selecting the particular thickness, stiffness, stretch property and elasticity of the upper layer and the positions of the support columns, the top surface of the upper layer may be specifically contoured to provide optimal support to the wearer's heel for a particular activity.

The support columns discussed herein may have various shapes. By way of example and not limitation, the support columns may have a circular, rectangular, square, elongated oval shape when viewed from the top of the bladder. Other shapes are also contemplated such as corrugated. It is contemplated that the support columns may have a symmetrical shape in that the upper and lower halves; the left and right halves of the support columns are symmetrical when viewed from the top. Moreover, the top and bottom halves of the support columns may be symmetrical when viewed from the side.

In another aspect of the bladder, an entire bottom surface of the lower layer may be generally flat for providing optimal performance for certain athletic maneuvers (e.g., board control while a skateboarder is riding). Since the base of the support column is attached to the generally flat lower layer, the attachment between the base of the support column and the lower layer may be characterized as a surface bond, a bond that occurs at a plane of the lower layer.

In another aspect of the bladder, the bladder may extend from a forefoot region through an arch region to a heel region. In this manner, the bladder may provide impact protection for the full length of the wearer's foot. In the event that an impact occurs in the forefoot region, the bladder may absorb such impact force and distribute such impact force throughout the entire length of the bladder. Likewise, in the event that an impact occurs at the arch region or the heel region, such impact forces may be distributed and absorbed throughout the entire bladder. Accordingly, despite the local impact on the bladder, the entire bladder may absorb such impact forces.

The bladder may be a single air tight enclosure fabricated from a resilient material. When an impact force is imparted onto a local area of the bladder, fluid contained within the bladder may become pressurized and press against the other areas of the bladder. The pressurized fluid pressing against the other areas of the bladder distribute and absorb the impact force imparted on the local area of the bladder. Accordingly, the entire bladder may absorb the impact force experienced at the local area of the bladder.

In another aspect of the bladder, the support columns may be filled with an impact absorbing material (e.g., polyurethane foam or gel). The impact absorbing material may work in parallel and/or series with the bladder to attenuate impact forces. It is also contemplated that the upper layer of the bladder may be formed with a stepped down cavity. The support columns may also be formed in the cavity. The impact absorbing material may be filled within the cavity as well as the support columns. In this manner, the impact absorbing material may extend to the bottom of the bladder to improve its impact resistance and resilience. Also, the impact absorbing material may be formed as a single uninterrupted insert. The single uninterrupted insert may be disposed in a general region (e.g., forefoot region, heel region, etc.) or be disposed along an entire length of the bladder.

The sole and the bladder discussed herein may be designed to provide various functions such as barrier protection, cushioning protection, and/or activity specific requirements. For example, in skateboarding, the sole and the bladder may incorporate aspects discussed herein to provide optimal stability, control, flexibility, board feel, responsiveness, regional adaptation to a range of forces and pressures, fit and conformance to the morphology of the plantar surface of the foot.

The bladder discussed herein may be formed by an extrusion blow molding process or a vacuum forming process. In the extrusion blow molding process, a parison may be extruded through a die. The parison forms the upper layer, the lower layer and the sidewall of the bladder. A wall thickness of the parison could be varied to vary the thickness of the upper layer, lower layer, and sidewall so as to fit the function of the bladder. For example, a round mandrel could be offset within a round aperture of a die. In this instance, the wall thickness of the parison would gradually increase from the one side of the parison to the other side of the parison. Likewise, the thickness of the upper layer, sidewall and lower layer may gradually increase.

In the vacuum forming process, an upper sheet forming the upper layer and sidewall may be disposed above a lower sheet forming the lower layer. The upper and lower sheets could be formed of different materials and/or thicknesses. In this manner, the bladder could be manufactured from two different materials and provide different rigidity and flexibility in the upper and lower layers based on the thickness and type of material of the first and second sheets. It is also contemplated that the bladder may be formed with any other process known in the art or developed in the future.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top perspective view of a sole of a shoe;

FIG. 2 is a top view of a bladder of the sole of the shoe shown in FIG. 1;

FIG. 3 is a rear perspective view of the bladder shown in FIG. 2;

FIG. 4 is a cross-sectional view of a support column of the bladder shown in FIG. 3;

FIG. 4A is a cross sectional view of a support column illustrating an alternate configuration of the column wall;

FIG. 4B is a cross sectional view of a support column illustrating a further alternate configuration of the column wall;

FIG. 4C is a cross sectional view of a support column illustrating a further alternate configuration of the column wall;

FIG. 5 is a cross-sectional view of a heel region of the bladder shown in FIG. 3;

FIG. 6 is a cross-sectional view of an upper layer between two support columns of the bladder shown in FIG. 3;

FIG. 7A illustrates an alternative embodiment of a connecting portion extending between a midsole and outsole of a sole;

FIG. 7B illustrates an alternative embodiment of the connecting portion extending between the midsole and outsole of the sole;

FIG. 8 is an alternative embodiment of the bladder shown in FIG. 2 with grooves extending between support columns;

FIG. 8A is a cross section of the groove;

FIG. 9 is a diagram of an extrusion blow molding process for fabricating the bladder;

FIG. 9A illustrates an embodiment of a die and mandrel for providing a non-uniform parison;

FIG. 9B is an alternate embodiment of the die and mandrel for controlling a thickness of the lower layer, peripheral wall and upper layer of the bladder;

FIG. 10 is a cross-sectional view of a parison shown in FIG. 9 when protrusions of a mold cause a first side of the parison to partially penetrate an opposed second side of the parison;

FIG. 11 is a diagram of a vacuum molding process for forming the bladder;

FIG. 12 is a top view of an alternate sole;

FIG. 13 is a side view of the sole shown in FIG. 12;

FIG. 14 is a cross-sectional view of the sole shown in FIG. 12;

FIG. 15 is a top view of the bladder with impact absorbing material disposed selectively at a forefoot region and at a heel region;

FIG. 16 is a top view of the bladder without impact absorbing material;

FIG. 17 is a top view of a bladder sized and configured to a heel region, impact absorbing material is not disposed on the bladder; and

FIG. 18 is a top view of a bladder sized and configured to a heel region with impact absorbing material disposed on the bladder.

### DETAILED DESCRIPTION

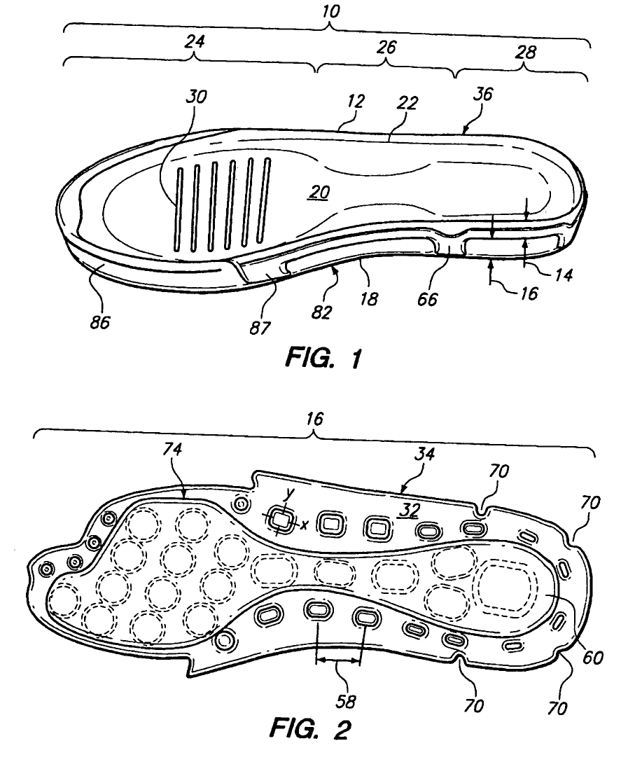

Referring now to FIG. 1, a sole 10 of a shoe is shown. The sole 10 discussed herein will be discussed in relation to a shoe. However, it is also contemplated that the various aspects of the sole 10 may be variously embodied and employed in other types of footwear. By way of example and not limitation, the various aspects of the sole 10 may be variously embodied and employed in footwear such as snow boots, snowboard boots, skateboard shoes, hiking boots, running shoes, sandals, slippers and flip flops. More generally, the various aspects of the sole 10 discussed herein may be variously embodied and employed in any and all types of footwear.

The sole 10 may have numerous purposes. For example, a basic purpose of the sole 10 may be to provide barrier protection to a bottom surface of a wearer's foot. When a wearer is walking on gravel or concrete, the gravel and concrete may pierce the bottom surface of the wearer's foot. Fortunately, the sole 10 may provide a protective barrier such that the wearer's foot is not damaged or cut by the gravel. Moreover, other types of sharp objects (e.g., broken glass) may pierce into the wearer's foot, but fortunately, the sole 10 protects the wearer's foot. If the shoe is worn for running, then the sole may provide the barrier protection function discussed above, and may also provide a cushioning function. More particularly, the sole 10 may provide optimal cushioning protection for the foot each time the runner's foot strikes the ground. In various extreme sports, the sole 10 may also provide other types of unique functions that are desirable and unique for that particular extreme sport. For example, in skateboarding, the wearer should have superior rear foot control of his/her board in that the time lag between the moment the skate boarder applies downward pressure with his/her foot to the moment such pressure is felt on the board should be minimal. Accordingly, the sole 10 should be rigid such that the skate boarder may perform extreme maneuvers and soft to provide impact protection to the skate boarder's feet, ankles, knees, hips and body. Other types of activities or extreme sports may require other or different combinations of functions. It is contemplated that the sole may be designed to provide such combination of functions by incorporating one or more of the aspects disclosed herein.

The sole 10 shown in FIG. 1 may be attached to a soft, flexible upper (not shown) that may comfortably surround an upper surface of a person's foot. A lower peripheral edge of the upper may be attached to an upper outer periphery or top gauge 12 (see FIG. 1) of the sole 10. The wearer's foot may be inserted between the upper and the sole 10. The upper may be used to hold the sole 10 between the wearer's foot and the ground or other support surface (e.g., skateboard, snowboard, etc.) while the wearer is engaging in a physical activity (e.g., walking, running, snowboarding, skateboarding, etc.).

The sole 10 may comprise a midsole 14, bladder 16 and an outsole 18. The midsole 14 shown in FIG. 1 may generally be at the upper side of the sole 10. The midsole 14 may also be the closest to the wearer's foot. The midsole 14 may provide a generally comfortable interface between the bottom surface of the wearer's foot and the sole 10. In a “stroble” or “California construction”, the bottom of the upper may be defined by a woven, cloth-like sock-liner. The stroble sock is used to close the upper. Other constructions are also contemplated that can serve the same purpose and be incorporated into the sole 10. It is also contemplated that the midsole 14 be fabricated from a variety of materials such as an elastomer, rubber, plastic, cork, or other materials that are currently used for a midsole 14 or that may be developed in the future. It is also contemplated that the midsole 14 may be fabricated from a combination of these materials.

The bed 20 (see FIG. 1) of the midsole 14 may have a variety of configurations. In particular, an outer peripheral portion or top net gauge 22 (see FIG. 1) of the midsole 14 which defines the top gauge 12 of the sole 10 may be curved upwardly to form a bed for the foot. The top gauge 12 may be attached to the upper. The top net gauge 22 of the midsole 14 may also follow a general pattern of the wearer's foot. For example, a forefoot region 24 and a heel region 28 may have a bulbous configuration which provides space for the heel and ball of the wearer's foot. In contrast, an arch region 26 may be slenderized. The bed 20 of the midsole 14 may have a generally flat contour. Although the bed 20 of the midsole 14 is shown as being generally flat, it is also contemplated that the bed 20 of the midsole 14 may be contoured to fit the bottom surface of the wearer's foot. The midsole 14 may also have transverse grooves 30 (see FIG. 1) formed at the forefoot region 24. The transverse grooves 30 may extend across a substantial portion of the width of the forefoot region 24 and may extend into the midsole 14 for a substantial depth. The transverse grooves 30 may provide for forefoot flex as the wearer is performing intricate maneuvers with his/her foot.

The midsole 14 may be attached to (e.g., molded over) the bladder 16 (see FIG. 1). In particular, a lower surface of the midsole 14 may be attached to an upper surface 32 (see FIG. 2) of the bladder 16 such as with adhesive, sonic welding, heat welding, melting via melt phase (discussed below) or other techniques known in the art or developed in the future. For example, the midsole 14 may be bonded to the bladder 16 by a melt phase. In particular, the material of the midsole 14 may be melted such that it can be poured over the bladder 16. As the melted bladder material is poured over the bladder, the heat from the melted bladder material melts the bladder thereby attaching the bladder and the midsole 14. An outer periphery 34 (see FIG. 2) of the bladder 16 may be smaller than an outer periphery 36 (see FIG. 1) of the midsole 14. When the midsole 14 is attached to the upper surface 32 of the bladder 16, the midsole 14 may cover the entire bladder 16. When viewed from a top of the midsole 14, the bladder 16 may be hidden by the midsole 14. In this regard, the wearer's foot may comfortably contact the midsole 14 and not contact the bladder 16 which may have various uncomfortable contours and indentations.

The bladder 16 may be a single air tight enclosure which continuously extends from the forefoot to the heel of the wearer's foot. In this manner, the bladder 16 may provide a cushioning function throughout the entire length of the wearer's foot. The bladder 16 may also have various stiff regions which may provide a quick response from the time that the wearer applies foot pressure to the midsole 14 to the time that the outsole 18 applies pressure to the ground or other support surface. Conversely, the stiff regions of the bladder provides better board feel such that the skateboarder may be able to better feel movement of the skateboard.

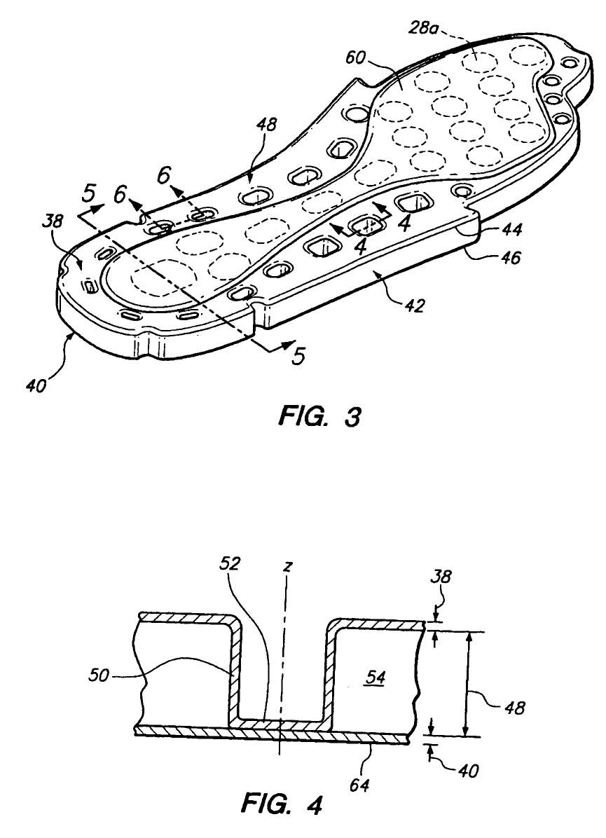

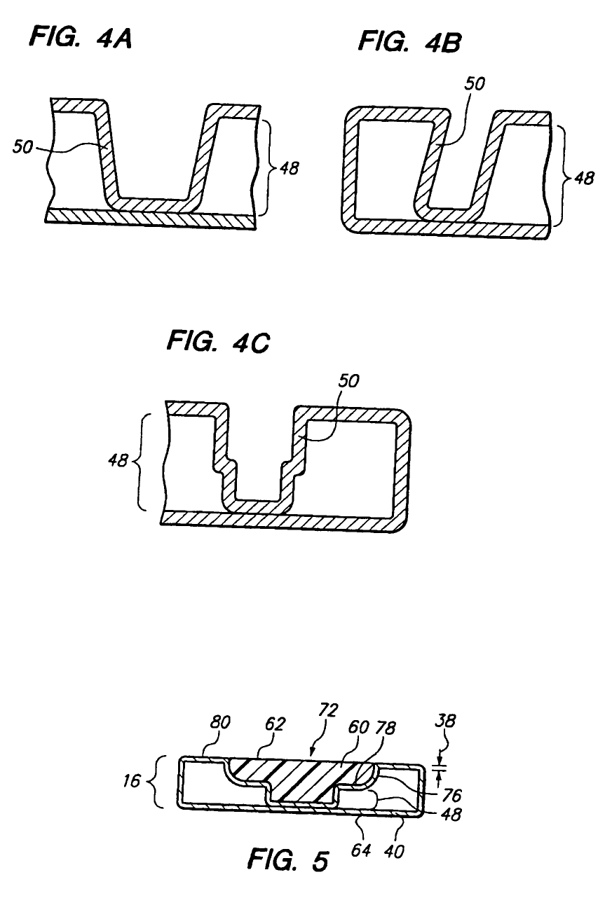

The bladder 16 may comprise an upper layer 38 (see FIGS. 3 and 4), a lower layer 40 (see FIGS. 3 and 4), and a peripheral wall 42 (see FIG. 3). The upper and lower layers 38, 40 of the bladder 16 may have a generally flat configuration. The upper and lower layers 38, 40 of the bladder 16 may be spaced apart and generally parallel with respect to each other. To maintain the space between the upper and lower layers 38, 40, the peripheral wall 42 may be attached to an outer periphery 44 (see FIG. 3) of the upper layer 38 and an outer periphery 46 (see FIG. 3) of the lower layer 40. The peripheral wall 42 may also be fabricated from a material that is sufficiently stiff to withstand a weight of the wearer, and other impact forces imposed upon the sole 10 while the wearer performs intricate foot work in an extreme sport or other activity. Support columns 48 (see FIGS. 3 and 4) may also be attached to the upper and lower layers 38, 40 to maintain the space between the upper and lower layers 38, 40. The support columns 48 may also be fabricated from a sufficiently stiff material to withstand the weight of the wearer and other impact forces.

One or more support columns 48 may be disposed in one or more of the forefoot region 24, arch region 26 or heel region 28. The support columns 48 may each comprise a column wall 50 (see FIG. 4) and a base 52 (see FIG. 4). The column wall 50 may extend between the upper layer 38 and the base 52. The support columns 48 may be integrally formed with the upper layer 38 and the base 52, as shown in FIG. 4. However, it is also contemplated that the support columns 48 may be separately formed from the upper layer 38. In this instance, the base 52 may be unnecessary and the column wall 50 may be in direct contact with or attached to the lower layer 40. Alternate embodiments of the support columns are also shown in FIGS. 4A-4C. In FIG. 4A, the column wall 50 of the support column 48 is skewed outward from the bottom to the top. In FIG. 4B, the column wall 50 of the support column 48 is slanted to one side. In FIG. 4C, the column wall 50 of the support column has a stepped configuration. These alternate embodiments of the support columns 48 may be incorporated into the various aspects discussed herein.

The support columns 48 may have various configurations, as shown in FIG. 2. By way of example and not limitation, the support columns 48 when viewed from a top of the bladder 16 may have a square configuration, a rectangular configuration, a circular configuration, an elliptical configuration, an oval configuration, an elongated oval configuration or any configuration that is symmetrical about a longitudinal x-axis and lateral y-axis of the support columns 48. Likewise, as shown in FIG. 4, when viewed from a side view, the support columns 48, and more particularly, the column wall 50 may be perpendicularly oriented with respect to the upper and lower layers 38, 40 of the bladder 16. It is contemplated that the support column 48 may have a symmetrical configuration about a vertical z-axis of the support column 48. It is also contemplated that the column wall 50 may have various configurations such as bowed inwardly, bowed outwardly, corrugated or angled. The various configurations of the support column provide different stiffnesses and response times that may be optimized to provide optimal functioning of the shoe for a particular extreme sport or activity. The support columns 48 may also be strategically positioned throughout the bladder 16 to provide optimal functioning of the shoe for a particular extreme sport.

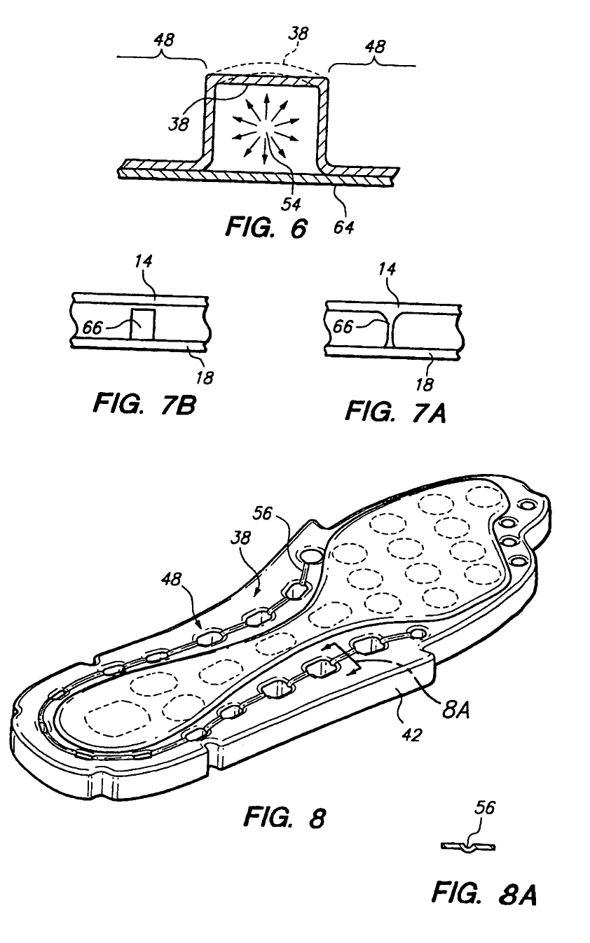

As discussed above, the bladder 16 may be a single air tight enclosure. A fluid 54 (see FIG. 6) such as gas or liquid may be disposed within the bladder 16. When the shoe is not worn, the pressure of the fluid 54 may be greater than the ambient pressure. By way of example and not limitation, the fluid 54 may be pressurized to from about five (5) psi to about twenty (20) psi. The pressure of the fluid 54 will push the upper layer 38, lower layer 40 and the peripheral wall 42 outwardly. As shown in FIG. 6, the fluid 54 when pressurized to a pressure greater than ambient pressure provides an outward force in all directions. The upper and lower layers 38, 40 of the bladder 16 will tend to be pushed away from each other. FIG. 6 illustrates the outward bowing of the upper layer 38 only for purposes of clarity. Fortunately, the support columns 48 maintain the distance between the upper and lower layers 38, 40 of the bladder 16. Due to the support columns 48, the bladder 16 does not balloon up.

As shown in FIG. 8, a groove 56 may be formed in the upper layer 38. The groove 56 is shown as extending between the support columns 48 but it is also contemplated that the grooves 56 may extend between the support columns 48 and the peripheral wall 42. The grooves 56 may mitigate the outward bowing of the upper layer 38 shown in FIG. 6. The grooves 56 may be filled with an impact absorbing material or stiff material. The groove 56 alone or the groove 56 in combination with the material disposed within the groove 56 may mitigate outward bowing of the upper layer 38. FIG. 8A illustrates a cross section of groove 56.

The upper layer 38, and more particularly, the upper surface 32 of the bladder 16 may be contoured by pressurizing the fluid 54 disposed within the bladder 16 to a pressure greater than ambient pressure and controlling the elasticity, stretchability, stiffness, thickness of the material forming the upper layer 38 as well as controlling a distance 58 (see FIG. 2) between the support columns 48. The greater the distance 58 between the support columns 48, the greater the outward bowing of the upper layer 38. Conversely, the smaller the distance 58 between the support columns 48, the smaller the outward bowing of the upper layer 38 therebetween. The bladder 16 may be optimized by controlling the above-mentioned factors for providing a footwear having optimal cushioning, support, stability, rear foot control, durability, flexibility, weight-reduction, pressure distribution and/or even fit.

The lower layer 40 may be sufficiently stiff such that any outward bowing of the lower layer between the support columns 48 is negligible. The lower layer 40 may be more stiff compared to the upper layer 38 such that the upper layer 38 may bow outwardly to provide support to the bottom surface of the wearer's foot, whereas, the lower layer 40 may be flat so as to rest on the ground or other support surface. In sum, the pressure of the fluid 54 pushes outwardly against the lower layer 40. The lower layer 40 may be fabricated to be stiff such that the outward bowing of the lower layer 40 due to the fluid pressure is negligible. The fluid pressure also pushes outwardly against the upper layer 38. The outward bowing of the upper layer 38 may be controlled by selecting the proper stiffness, stretchability, elasticity and other characteristics of the upper layer 38 as well as selectively positioning the support columns.

The upper layer 38 may be stepped downwardly, as shown in FIG. 5. The downward step may form a cavity 72 that extends from one or more of the following regions, namely, the forefoot region 24, the arch region 26, and the heel region 28. The cavity 72 may have an outer periphery 74 (see FIG. 2) which may have a foot shape, as shown in FIG. 2. The outer periphery 74 of the cavity 72 may also be smaller than an outer periphery 34 (see FIG. 2) of the bladder 16. The outer periphery 74 (see FIG. 2) of the cavity 72 may have a bulbous portion at the forefoot region 24, a slenderized region at the arch region 26 and another bulbous configuration at the heel region 28. The cavity 72 may be formed by stepping the upper layer 38 of the bladder 16 downward, as shown in FIG. 5. To this end, the cavity 72 may be defined by a cavity wall 76 which defines the outer periphery 74 of the cavity 72 and a cavity floor 78. The cavity floor 78 may be attached to a lower edge of the cavity wall 76. Similar to the support columns 48 formed between the upper and lower layers 38, 40 of the bladder 16, support columns 48 may be formed between the cavity floor 78 of the cavity 72 and the lower layer 40 of the bladder 16, as shown in FIGS. 3 and 5.

An impact absorbing material 60 may be filled within the cavity 72 and also within the support columns 48 formed between the cavity floor 78 and the lower layer 40 of the bladder 16. The impact absorbing material 60 may be an elastomer such as an ethylene vinyl acetate (“EVA”), or phylon, polyvinyl chloride (“PVC”), silicone rubber, synthetic rubber, olefins, polyurethane, polyurethane foam, gel or the like. The absorbing materials 60 may define an upper surface 62 (see FIG. 5). The upper surface 62 of the impact absorbing materials 60 may be about level or substantially co-planar with an upper surface 80 (see FIG. 5) of the upper layer 38.

The stepped construction allows for the impact absorbing material 60 to be uninterrupted. The impact absorbing material 60 filled within the support columns located in the cavity are attached to each other at the upper portion of the impact absorbing material 60. Since the impact absorbing material 60 fills the cavity including the support column, the impact absorbing material extends down to the lower layer thereby improving the impact resistance and resiliency. The stepped construction of the cavity also allows the impact absorbing material to be easily poured into the cavity instead of individually fitted and cemented to the bladder.

The outsole 18 (see FIG. 1) may be attached to a bottom surface 64 (see FIG. 5) of the lower layer 40. The outsole 18 may be fabricated from a material which is strong, resilient and wear resistant. By way of example and not limitation, the outsole 18 may be fabricated from an elastomeric material, synthetic rubber, polyurethane, etc. A bottom surface of the outsole 18 and the type of material selected for the outsole 18 may be optimized to (1) increase the frictional coefficient between the shoe and the ground or other contact surface and/or (2) resist wear.

The outsole 18 may be attached underneath the bladder 16. The outsole 18 may extend over the entire bladder 16 for providing protection to the bladder 16 from sharp objects that may pierce a hole through the bladder 16. The outsole 18 may also define an outer periphery 82 (see FIG. 1) which has substantially same shape and size as the outer periphery 36 (see FIG. 1) of the midsole 14. A bottom surface of the outsole 18 may have various grooves and protrusions for increasing frictional forces between the bottom surface of the outsole 18 and the contact surface or ground and for allowing the shoe to bend to the natural bend of the wearer's foot such as when the wearer is walking or running.

As shown in FIG. 1, the midsole 14 and the outsole 18 may be physically attached to each other by optional connecting portions 66. There may be one or more (e.g., four) connecting portions 66 which are disposed at the heel region 28 of the sole 10. The connecting portions 66 do not provide reinforcement to the bladder 16 to resist the pressure of the fluid 54 contained within the bladder 16. Rather, the type of bladder material, the thickness of the bladder material and the positioning and number of support columns 48 may provide the only reinforcement for the bladder 16 such that the pressure of the fluid 54 does not excessively expand (i.e., balloon) the bladder 16. The connecting portion 66 may be recessed within the bladder 16 at recesses 70.

At the heel region 28, connecting portions 66 may be attached to the midsole 14 and extend down to the outsole 18. These connecting portions 66 provide aesthetic appeal or abrasion resistance. It is also contemplated that the connecting portion 66 may be slenderized, as shown in FIG. 7A. Although the connecting portion 66 shown in FIG. 1 extend from the midsole 14 to the outsole 18, it is contemplated that a break may be formed between either (1) the connecting portion 66 and the midsole 14 (see FIG. 7B) or (2) the connecting portion 66 and the outsole 18.

Typically, as a wearer walks or engages in a physical activity, the forefoot region 24 may bump or hit a wall, ground, or other objects. The forefoot region 24 may be formed with a wall portion 86 (see FIG. 1) disposed in front of the shoe. The wall portion 86 may extend from the outsole 18 to the midsole 14 or to the upper. The wall portion 86 may be fabricated from the same material as the outsole 18 by extending the outsole material upward. A second wall portion 87 (see FIG. 1) may be formed behind the wall portion 86 by extending the material of the midsole 14 downward to the outsole 18. The wall portions 86, 87 provide a bed for the bladder 16.

In an aspect of the sole 10, the bladder 16 may be fabricated via an extrusion blow molding process. A discussion of fabricating the bladder 16 via the extrusion blow molding process will be discussed herein. However, it is also contemplated that the bladder 16 may be fabricated via other forming processes such as injection blow molding, stretch blow molding or vacuum forming process.

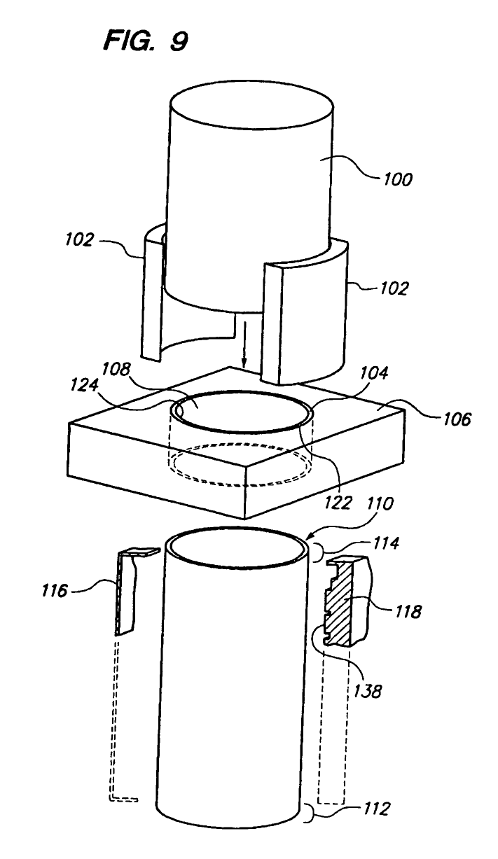

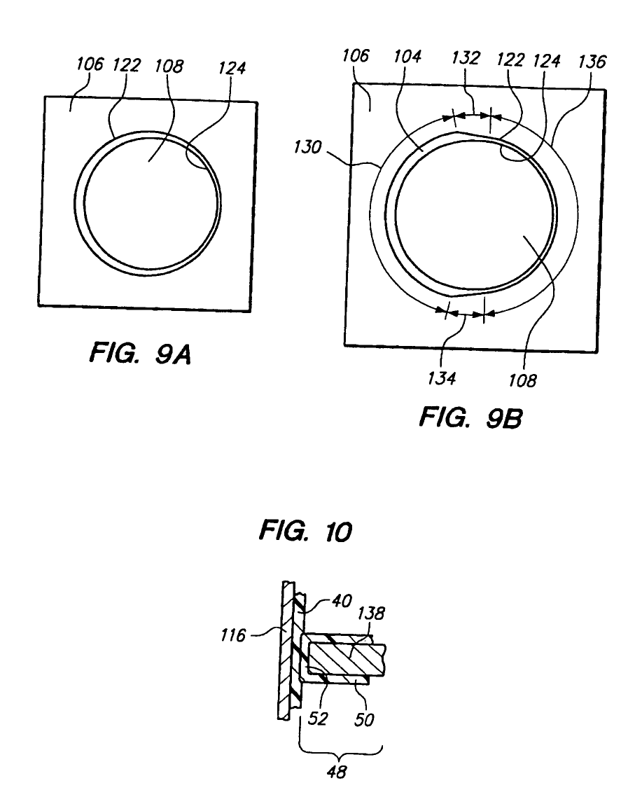

FIG. 9 is a diagram of an extrusion blow molding process. Initially, the material of the bladder 16 may be provided in solid form as a blank 100. The blank 100 may be heated to a temperature above the melting temperature of the blank 100 by heaters 102. The molten blank 100 is then pushed through an opening 104 of a die 106. The die 106 may also have a mandrel 108 disposed in a central area of the opening 104. The molten blank 100 may be extruded out of the die 106/mandrel 108 combination as a molten hollow tube or a parison 110. The parison 110 may define a first end portion 112 and an opposing second end portion 114. The first end portion 112 may be sealed (e.g., crimped) so as to be air tight. The lumen of the parison 110 may be slightly pressurized. Thereafter, a first half 116 of a mold may be brought together against a second half 118 of the mold. The first and second halves 116, 118 of the mold may collectively form the flat bottom contour of the bladder 16 as well as the support columns 48 between the upper and lower layers 38, 40 of the bladder 16. Thereafter, the fluid 54 disposed within the formed parison 110 may be pressurized to a pressure greater than ambient pressure. After the first and second halves 116, 118 of the mold are detached from each other, the pressure within the bladder 16 may form various curvatures in the upper layer 38 of the bladder 16 as dictated by the parameters of the bladder material and support columns 48, as discussed above. At this point, the bladder 16 comprises a single air tight airbag.

As shown in FIG. 9, the periphery 122 of the opening 104 may be circular. However, it is also contemplated that the periphery 104 may have other configurations such as oval, elliptical, rectangular, square or the like. The mandrel 108 may have an outer periphery 124. The outer periphery 124 of the mandrel 108 may closely follow the inner periphery 122 of the opening 104 of the die 106, as shown in FIG. 9. The distance from the inner periphery 122 of the opening 104 to the outer periphery 124 of the mandrel 108 may be consistent about the entire circumference of the mandrel 108 and opening 104. As a result, the parison 110 may have a uniform thickness, as shown in FIG. 9. Alternatively, the distance between the outer periphery 124 of the mandrel 108 to the inner periphery 122 of the opening 104 may vary about the circumference of the mandrel 108 and opening 104, as shown in FIG. 9A. In this regard, the parison 110 may have a thickness which varies about its circumference. The thickness of the parison 110 wall formed by the mandrel 108 and die 106 combination shown in FIG. 9A will vary. On a first side of the parison 110, the wall thickness will be thinner compared to a wall thickness of a second opposed side of the parison 110. The thickness of the wall of the parison 110 shown in FIG. 9A may gradually increase from the first side to the second side. The bladder 16 fabricated from the parison 110 shown in FIG. 9A may have a varying wall thickness wherein its wall thickness may be thinnest at a central region of the upper layer 38 of the bladder 16 and gradually increase as measurements are taken to the central area of the lower layer 40 of the bladder 16.

FIG. 9B illustrates an alternative mandrel 108 and die 106. In this embodiment, the outer periphery 122 of the opening 104 may have a distinctive shape and the outer periphery 124 of the mandrel 108 may have a corresponding shape. The mandrel 108 and the die 106 along length 130 may define the lower layer 40 of the bladder 16. The length 132 and length 134 may define the peripheral wall 42 of the bladder 16. The length 136 may define the upper layer 38 of the bladder 16 as well as the column wall 50 and the base 52 of the support columns 48. As can be seen from FIG. 9B, the thickness of the parison 110 at length 130 is thicker compared to the length 132, 134 and 136. This fabricates a stiffer lower layer 40 compared to the peripheral wall 42 and upper layer 38. The length 132 and 134 may still be substantially thick so as to provide stiffness to the peripheral wall 42. These lengths 132, 134 may form the peripheral wall 42.

From the foregoing discussions, it is apparent that the upper and lower layers 38, 40 of the bladder 16 as well as the support columns 48 may have different characteristics including but not limited to the characteristics of stretchability, elasticity, stiffness, thickness, and the distance between support columns such that the bladder 16 may be optimized for cushioning, support and other functions described herein or known in the art or developed in the future. The lower layer 40 of the bladder 16 may be thick such that it is sufficiently stiff such that the pressure of the fluid 54 does not excessively bow the lower layer 40. In contrast, the upper layer 38 of the bladder 16 may be sufficiently thin to allow the pressure of the fluid 54 disposed within the bladder 16 to outwardly bow the upper layer 38 to provide optimal support and cushioning for the wearer's foot. The support columns 48 may be positioned or spaced apart from each other to control the outward bowing of the upper layer to provide optimal support and cushioning.

In an aspect of the process of the extrusion blow molding, the second half 118 of the mold may have a plurality of protrusions 138 (see FIG. 9). These protrusions 138 may form the support columns 48. As discussed above, the parison 110 is slightly pressurized when the first and second halves 116, 118 of the mold are closed upon each other. The protrusions 138 extend from the second side of the parison to the first side of the parison 110. The protrusions 138 are sufficiently long such that the inner surface of the parison 110 slightly penetrates the inner surface of the parison 110 at the first side thereof, as shown in FIG. 10. The slight interference produces a secure surface bond or mechanical lock between the base 52 of the support column 48 to the lower layer 40 of the bladder 16.

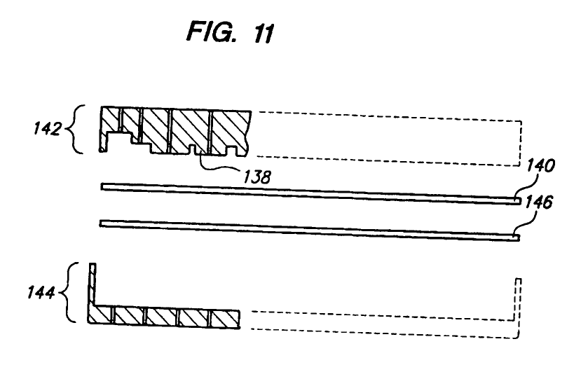

Referring now to FIG. 11, the bladder 16 may alternatively be fabricated from a vacuum forming process. In particular, a first sheet 140 may be disposed between first and second mating molds 142, 144. A second sheet 146 may be disposed between the first sheet 140 and the second mold 144. The second mold 144 may form the bottom layer 40, whereas, the first mold 142 may form the peripheral wall 42, contour of the upper layer 38, support columns 48, and the cavity 72. With the first and second sheets 140, 146 disposed between the first and second molds 142, 144, the first and second molds 142, 144 may be closed upon each other. The first sheet 140 is then vacuumed against the inner surface of the first mold 142 to form the contoured upper surface 32 of the bladder 16. Likewise, the second sheet 146 may be vacuumed against the inner surface of the second mold 144 to form the flat contoured surface of the lower layer 40 of the bladder 16.

The first mold 142 may have various protrusions 138 which define the support columns 48 and the cavity 72. The base 52 of the support columns 48 may be attached (e.g., surface welded) to the lower layer 40 or the second sheet 146 through sonic welding, adhesion, heat welding or other methods known in the art or developed in the future. As discussed above, similar to the blow molding process, the protrusion 138 may extend the first sheet 140 into the second sheet 146 to create a secure attachment between a base 52 of a support column and the lower layer 40. For example, the support columns 48 may be formed by melting the first sheet 140 and indenting the first sheet 140. The indented portion of the first sheet 140 eventually contacts the second sheet 146. The heat from the indented portion is transferred to the second sheet to thereby at least partially melt the second sheet 146. The melted portion of the second sheet 146 and the indented melted portion of the first sheet 140 may become attached to each other.

The vacuum forming process permits the bladder to be fabricated from two different materials. By way of example and not limitation, the first sheet 140 may be fabricated from thermoplastic material which may be more stretchable, elastic and less stiff compared to the second sheet 146 which may be fabricated from a thermoplastic PU. In this manner, the lower layer 40 may remain flat even though the pressure of the fluid 54 is at a pressure greater than ambient pressure. Also, the first sheet 140 which forms the upper layer 38 may be contoured. Accordingly, the bladder 16 may be fabricated from at least two different materials which exhibit different physical properties that may be optimal for the bladder's function. The differences in physical characteristics may be in relation to thickness, hardness, texture or color. It is contemplated that the types of material for the first and second sheets 140, 146 may include a thermoplastic material, polyurethane (PU), polyvinyl chloride (PVC), high density polyethylene (HDPE), polycarbonate (PC), polypropylene (PP), polyethylene terephtalate glycol (PETG), etc.

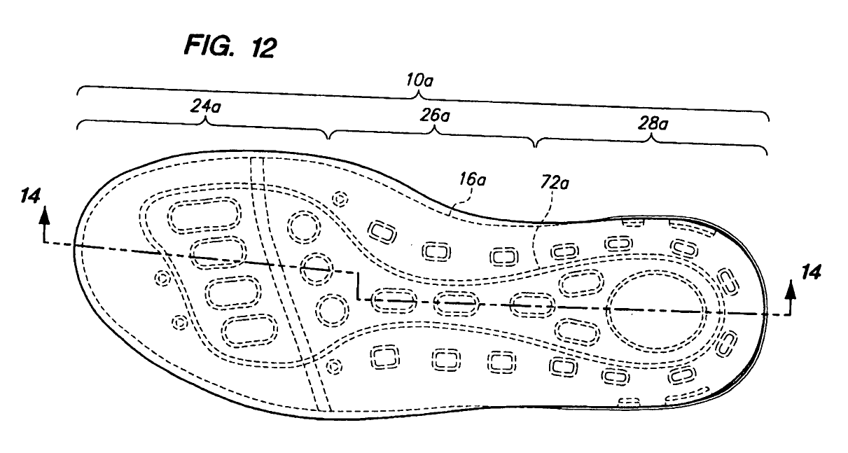

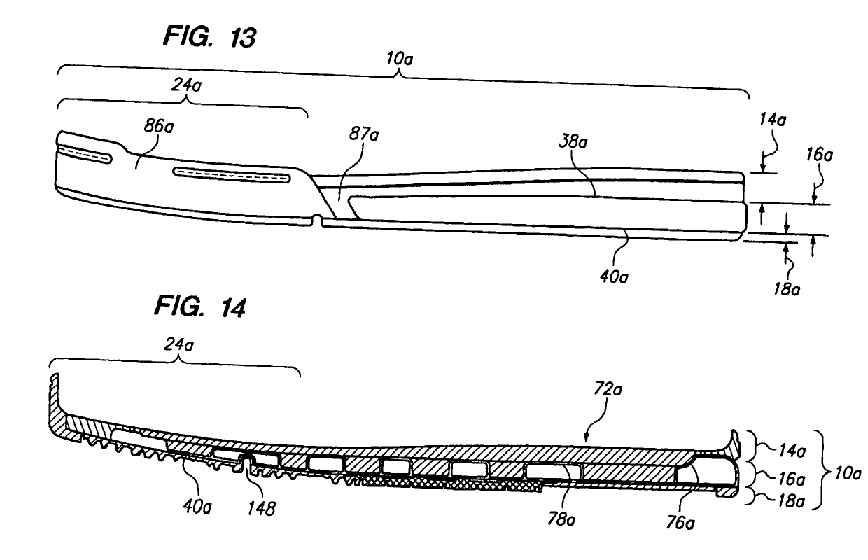

Referring now to FIGS. 12-14, a second embodiment of the sole 10a is shown. The sole 10a may have a midsole 14a, outsole 18a and a bladder 16a, as shown in FIG. 13. The bladder 16a shown in FIG. 12 may incorporate one or more of the aspects discussed in relation to the bladder shown in FIGS. 2 and 8. The bladder 16a may be a single air tight bag which extends from a heel region 28a through an arch region 26a to a forefoot region 24a. The bladder 16a may have a generally flat lower layer 40a (see FIG. 13) and a generally flat upper layer 38a (see FIG. 13). The upper layer 38a may form a cavity 72a. The cavity 72a may be filled with an impact absorbing material 60a. Support columns 48a may be attached to the upper and lower layers 38a, 40a of the bladder 16 in the heel region, 28a, arch region 26a, and forefoot region 24a. As shown in FIG. 12, a plurality of support columns 48a may be positioned about the outer periphery of the bladder 16a at the arch region 26a and the heel region 28a. Additionally, support columns 48a may also be formed between a cavity floor 78a of the cavity 72a and the lower layer 40a. The support columns 48a disposed at the peripheral portion of the heel region 28a may be smaller than the support columns 48a disposed at the peripheral portion of the arch region 26a. The cavity 72a and the support columns 48a formed between the cavity floor 78a and the lower layer 40a may be filled with impact absorbing material 60a. Also, the bladder 16a may be filled with a fluid and pressurized to a pressure greater than ambient pressure.

As shown in FIG. 13, the midsole 14a may be attached to the upper layer 38a of the bladder 16a. The outsole 18a may also be attached to the lower layer 40a of the bladder 16a. In contrast to the sole 10 shown in FIG. 1, the midsole 14a and the outsole 18a are not attached to each other with connecting portions 66.

The forefoot region 24a may have a wall portion 86a (see FIG. 13) which covers the outer periphery of the bladder 16a for the purposes of abrasion and grip. The wall portion 86a may be fabricated by extending the outsole material upward. A second wall portion 87a may be formed behind the wall portion 86a. The wall portion 87a may be formed by extending the midsole material 14 downward. The wall portions 86a, 87a may provide a bed for the bladder 16a.

The sole 10a shown in FIG. 14 is a cross-sectional view of the sole 10a shown in FIG. 12. The sole 10a comprises the bladder 16a which may extend an entire length of the wearer's foot. As can be seen, the lower layer 40a of the bladder 16a at the forefoot region 24a is curved slightly upwardly. Nonetheless, the lower layer 40a may still be characterized as generally flat. Additionally, the lower layer may have a groove 148 which may extend transversely across a longitudinal axis of the sole 10a. The groove 148 permits the forefoot region 24a to bend upwardly as the wearer walks, runs or performs complex foot maneuvers while participating in an extreme sport.

The bladder 16a discussed above may be fabricated with the extrusion blow molding process discussed above or the vacuum forming process discussed above or any other processes discussed herein, known in the art or developed in the future.

In an aspect of the bladder 16, 16a, as shown in FIG. 14, the cavity wall 76a may curve downwardly as the cavity wall 76a approaches the cavity floor 78a. This is in contrast to the cavity wall 76 shown in FIG. 5 which extends perpendicular with respect to both the upper layer 38 and the cavity floor 78 shown in FIG. 5.

In an aspect of the bladder 16, 16a, the bladder may be fabricated from a material which is transparent. Since the bladder 16, 16a is fabricated from a transparent material, a person may see through the bladder to the extent that the connecting portions 66 and wall portion 86, 86a, 87, 87a do not block the view from the bladder 16, 16a.

In an aspect of the bladder 16, 16a, the bladder 16, 16a may also be disposed within the sole 10, 10a upside down.

In an aspect of the sole 10, 10a, the midsole 14, 14a and the outsole 18, 18a may be attached to the bladder 16, 16a by molding the midsole 14, 14a and the outsole 18, 18a over the bladder 16, 16a. For example, the midsole 14, 14a and outsole 18, 18a may be melted and poured over the bladder 16, 16a. The heat from the melted midsole 14, 14a and outsole 18, 18a may melt the bladder 16, 16a thereby attaching the bladder 16, 16a to the midsole 14, 14a and the outsole 18, 18a.

In an aspect of the bladder 16, 16a, it is contemplated that bladder 16, 16a may be fabricated from the following types of materials including but not limited to a thermoplastic material, thermoplastic polyurethane, polyurethane, polyvinyl chloride, high density polyethylene (HDPE), polycarbonate (PC), polypropylene (PP), polyethylene terephtalate glycol (PETG), etc. It is also contemplated that the upper and lower layers may be at least one (1.0) mm thick.

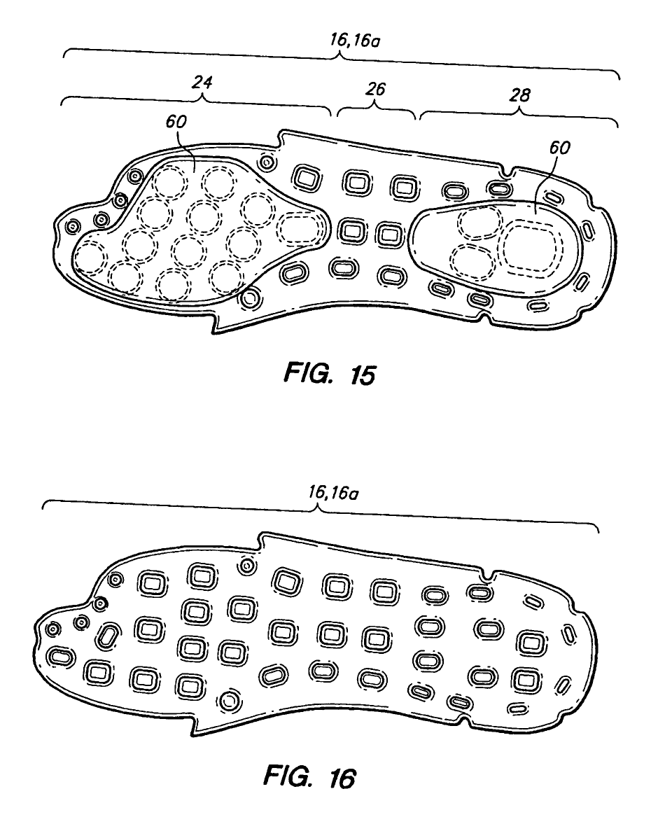

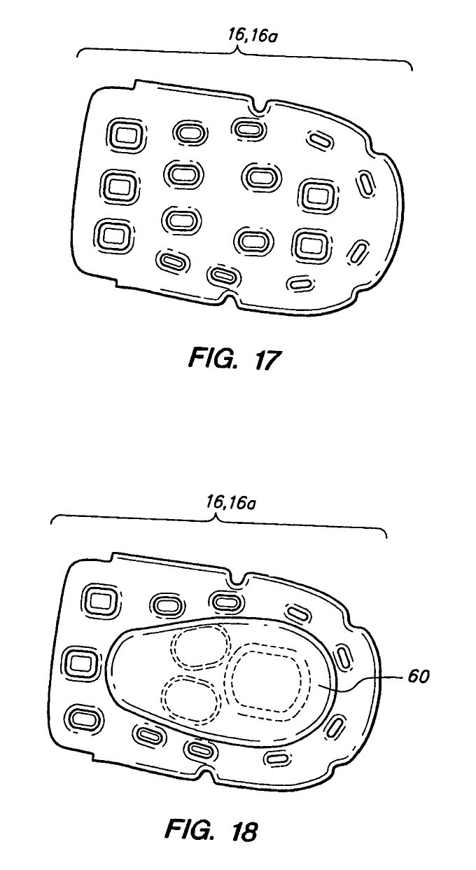

In an aspect of the sole 10, the bladder 16, 16a may extend across an entire length of the wearer's foot, as shown in FIGS. 15 and 16. Alternatively, it is contemplated that the bladder 16, 16a may cover a heel region of the wearer's foot, as shown in FIGS. 17 and 18. Additionally, although not shown, it is contemplated that the bladder 16, 16a may extend or cover the forefoot region of the wearer's foot only. It is also contemplated that the bladder 16, 16a may not incorporate the impact absorbing material, as shown in FIGS. 16 and 17. Also, the impact absorbing material 60 may be fitted within the heel region, as shown in FIGS. 15 and 18. Also, the impact absorbing material 60 may be separated so as to cover the heel region 28 and the forefoot region 24, but not the arch region 26, as shown in FIG. 15.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A cushion for a sole of a footwear, the cushion comprising:
a hermetically sealed airbag, the airbag defining a first layer and an opposed second layer, the first layer spaced apart from the second layer, the first layer having a different stiffness compared to the second layer; and
a fluid disposed within the airbag for mitigating impact forces.

2. The cushion of claim 1 wherein at least one portion of the first layer is attached to the second layer for providing structural support to the first layer when the airbag is pressurized.

3. The cushion of claim 2 wherein the cushion consists essentially of:
a hermetically sealed airbag, the airbag defining a first layer and an opposed second layer, the first layer spaced apart from the second layer, at least one portion of the first layer attached to the second layer for providing structural support to the first layer when the airbag is pressurized, the first layer having a different stiffness compared to the second layer; and
a fluid disposed within the airbag for mitigating impact forces.

4. The cushion of claim 1 wherein the material of the first layer is less stiff compared to the material of the second layer.

5. The cushion of claim 1 wherein the materials of the first and second layers each have a thickness and defines a stretchability and an elasticity, and at least one of the thickness, stretchability and elasticity of the first layer is different than the thickness, stretchability and elasticity of the second layer.

6. The cushion of claim 1 wherein the first layer is an upper layer, the second layer is a lower layer, and the portion of the first layer attached to the second layer has a column configuration.

7. The cushion of claim 1 wherein the first and second layers are generally flat.

8. A cushion for a sole of a footwear, the cushion comprising:
a first layer defining an outer peripheral portion;
a second layer defining an outer peripheral portion and an exterior surface, the second layer being less stretchable and more stiff compared to the first layer, a substantial portion of the exterior surface of the second layer being generally flat, the outer peripheral portion of the second layer sealed to the outer peripheral portion of the first layer for forming an airtight airbag;
fluid disposed within the airtight airbag at a pressure greater than ambient pressure;
a plurality of support columns extending between and attached to the first and second layers, the support columns being configured to oppose outward forces of the pressurized fluid applied to the first layer.

9. The cushion of claim 8 wherein at least a heel region of the exterior surface of the second layer is generally flat.

10. The cushion of claim 8 wherein the support column has a circular, rectangular, square, oval, or elliptical configuration.

11. The cushion of claim 8 wherein the second layer is sufficiently stiff to prevent excessive bowing of the second layer due to the fluid pressure.

12. The cushion of claim 8 wherein the second layer is sufficiently stiff such that the second layer is generally flat despite outward pressure of the fluid on the second layer, and the second layer is sufficiently elastic and stretchable and the support columns selectively positioned such that the second layer is contoured due to the outward pressure of the fluid on the second layer and positioning of the support columns to provide support to the wearer's foot.

13. The cushion of claim 8 further comprising grooves formed in the second layer between two support columns and between one support column and a peripheral wall attached to the outer peripheral portions of the first and second layers.

14. The cushion of claim 8 further comprising an external cavity formed in the first layer and an impact absorbing material disposed within the external cavity, and wherein the external cavity is defined by a cavity floor elevationally disposed between the first and second layers and a cavity wall attached to the cavity floor and the first layer.

15. The cushion of claim 8 further comprising an impact absorbing material disposed within at least one support column.

16. A method for forming a bladder of a footwear, the method comprising the steps of:
extruding a parison having a first distal end portion and an opposed second distal end portion;
sealing the first distal end portion;
pressurizing the parison to a pressure above ambient pressure and below a target pressure;
providing first and second molds traverseable between an open position and a closed position, the first mold having protrusions for forming a support column in the bladder;
traversing the first and second molds to the closed position to form the bladder;
pressurizing the formed bladder to the target pressure;
traversing the first and second molds to the open position to remove the bladder from the first and second molds.

17. The method of claim 16 wherein the traversing the first and second molds to the closed position step includes performing such step while maintaining the pressure within the parison above ambient pressure and below a target pressure for forming the bladder.

18. The method of claim 16 wherein the extruding step includes extruding a parison with a thickness of a wall of the parison that varies about a circumference of the parison.

19. The method of claim 16 wherein the traversing the first and second molds to the closed position comprises the step of traversing the protrusion of the first mold to the second mold such that a first side of the parison penetrates into a second side of the parison when the molds are traversed to the closed position for attaching a base of the support column to the second side of the parison.

20. A method for forming a bladder of a footwear, the method comprising the steps of:
providing a first mold and an opposing second mold;
providing first and second sheets which collectively form the bladder, the first and second sheets each defining a stiffness, stretch property, elasticity and thickness, at least one of the stiffness, stretch property, elasticity and thickness of the first sheet being different from the second sheet;
disposing the first sheet between the first and second molds;
disposing the second sheet between the first sheet and the second mold;
traversing the first and second molds to a closed position; and
drawing the first sheet against an interior surface of the first mold and the second sheet against an interior surface of the second mold for forming the bladder.

21. The method of claim 20 wherein providing the first mold step includes providing the first mold with at least one protrusion for forming a support column in the bladder.

22. The method of claim 20 wherein the providing the first and second sheets includes the step of providing different materials for the first and second sheets.
